(19) United States
(12) Patent Application Publication
(10) Pub. No.: US 2013/0185168 A1
(43) Pub. Date: Jul. 18, 2013

(54) METHODS AND SYSTEMS FOR AUTOMATED POST-AUCTION CHANGE ORDER OPTIMIZATION IN AUCTIONS

(71) Applicants: Haengju Lee, Webster, NY (US); Yu-An Sun, Webster, NY (US)

(72) Inventors: Haengju Lee, Webster, NY (US); Yu-An Sun, Webster, NY (US)

(73) Assignee: Xerox Corporation, Norwalk, CT (US)

(21) Appl. No.: 13/353,277

(22) Filed: Jan. 18, 2012

(51) Int. Cl. G06Q 30/08

(52) U.S. Cl. 705/26.3

(57) ABSTRACT

Methods, systems, and computer-readable media for providing an optimized change order during the post-auction period of a completed auction. After the completion of an initial auction, one or more parties to the initial auction may request a change to the terms of the initial auction agreement in the form of a change order comprising a change price and a change quantity. Prior to committing to the change order the parties may subject the terms of the change order to a change auction having a reserve price equal to the change price. If the change auction concludes with a bid that is better than the reserve price, the change order may be canceled and the original winning bidder may receive a portion of the winning bid associated with the change auction.

### TECHNICAL FIELD

The present disclosure relates generally to methods, systems, and computer-readable media for implementing improved auctions.

### BACKGROUND

Auctions have traditionally been an efficient way for buyers and sellers of goods and services to agree to transactions at optimum prices. The bidding process allows for the party initiating the auction (hereinafter, “auctionor”) to obtain the maximum or minimum price achievable from a bidding group that includes multiple, different bidders. The bidding usually ends when a bidder bids a price that is higher or lower, depending on the type of auction, than any other price bid, and no other bidder is willing to beat that price.

Normally, at the end of an auction, there is an agreement between the auctionor and the winning bidder to exchange goods or services for the winning bid amount. However, unforeseen circumstances can sometimes necessitate a change to the agreement. For example, a winning bidder-seller may determine that it is unable to provide all of the services specified in an auction agreement, or an auctionor-buyer may determine that it no longer needs all of the services specified in the auction agreement.

In some cases, in order to maintain good will and positive business relationships, buyers and sellers may agree to a “change order” under these circumstances. A change order changes the terms of the original auction agreement and usually involves bargaining for a new price (hereinafter “change price”) and a new quantity of goods or services (hereinafter “change quantity”). However, the prospect of a change order can leave both parties in a state of uncertainty. Since the new agreement, unlike the original agreement, was not subjected to a multi-party bidding process, neither party may be certain that the change price reflects an optimal bargain.

An auctionor facing a possible change order may be forced to make a difficult decision. On the one hand, the auctionor could decide to accept the change order without knowing whether the change price reflects an optimum price. On the other hand, the auctionor could forfeit the offered change price, initiate a new auction, and risk concluding the new auction at a new price that is less desirable than the change price offered by the original winning bidder.

Therefore, there is a need for methods, systems, and computer-readable media for addressing these and other deficiencies presented by change orders in the auction context.

### SUMMARY OF THE INVENTION

The present disclosure relates generally to methods, systems, and computer-readable media for providing an optimized change order during the post-auction period of a completed auction.

In some embodiments, when one or both parties request a change order after a completed auction, the parties may elect to hold a “change auction.” During the change order process, the parties may agree to a change price and a change quantity. However, when a change auction is elected, the change order is subject to the results of the change auction.

If a change auction is elected, the parties may agree to a reserve price and a change auction quantity. The reserve price may be equal to the change price, and the change auction quantity may be equal to the change quantity. During the change auction, if no bidder outbids the reserve price by the end of the change auction period, the original winning bidder and the auctionor may enter into an agreement for the change quantity at the change price. If, however, a new bidder (hereinafter, “new winning bidder”) outbids both the reserve price and all other bidders in the change auction, the new winning bidder may then enter into an agreement with the auctionor for the exchange of the goods or services specified in the change auction for a price equal to the new winning bidder's winning bid.

The original winning bidder may be incentivized to agree to the change auction by the offering of a switch price, which represents an amount to be paid to the original winning bidder in the event that a new winning bidder is successful in the change auction. In some embodiments, the switch price may be calculated by multiplying the difference between the new winning bidder's winning bid in the change auction and the change price by a switch ratio (e.g., a number between zero and one). The switch ratio may be determined before or after the parties agree to subject the change order to a change auction, depending on the implementation. The switch ratio may be dynamically determined by the auctioning system, may be specified by either party with or without a bargaining process, or may be a fixed number built into the auctioning system.

After the completion of the change auction, if there is a successful new winning bidder, the auctionor may pay the switch price to the original winning bidder. When the switch ratio is less than one, the auctionor may benefit from the change auction. For example, if the auctionor is a buyer, then the auctionor will pay a total amount that is less than the change price—in effect, a discount. Alternatively, if the auctionor is a seller, then the auctionor will receive a net payment that is the amount paid by the new winning bidder minus the switch price paid to the original winning bidder. Since the net payment will still be greater than the change price, the auctionor will, in effect, receive a premium. And, in either case, the original winning bidder will receive payment in the form of the switch price, despite the absence of any executed transaction with the auctionor for the sale of goods or services.

Thus, by electing to subject the change order to a change auction, the auctionor can hold a new auction without the risk of forfeiting the deal brokered with the original winning bidder as part of the change order. The auctionor is therefore not forced to decide between accepting the change price and initiating a new auction that might not be as advantageous as the change price. Additionally, the change auction may be advantageous to the original winning bidder, since the original winning bidder can expect to benefit either from a transaction with the auctionor at the change price or from a payment equal to the switch price. In some cases, the switch price may even be greater than the profit expected by a seller-original winning bidder at the bargained-for change price or greater than the net worth of the change order agreement to a buyer-original winning bidder.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an exemplary network configuration that may be used to conduct an online auction that provides for a post-auction change order with a change auction option, consistent with certain disclosed embodiments;

FIG. 2 is a diagram depicting an exemplary hardware configuration for various devices that may be used to perform one or more operations of the described embodiments, consistent with certain disclosed embodiments;

FIG. 3 is a diagram depicting an exemplary data store configuration for an online auction system that may be used to perform one or more operations of the described embodiments, consistent with certain disclosed embodiments;

FIG. 4 is a flow diagram illustrating an exemplary method of implementing a post-auction change order with a change auction option, consistent with certain disclosed embodiments;

FIG. 5 is a flow diagram illustrating an exemplary method of calculating a switch ratio, consistent with certain disclosed embodiments; and

FIG. 6 is a flow diagram depicting an exemplary sequence in which a change auction may be conducted as part of a change order during the post-auction period of a completed auction, consistent with certain disclosed embodiments.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

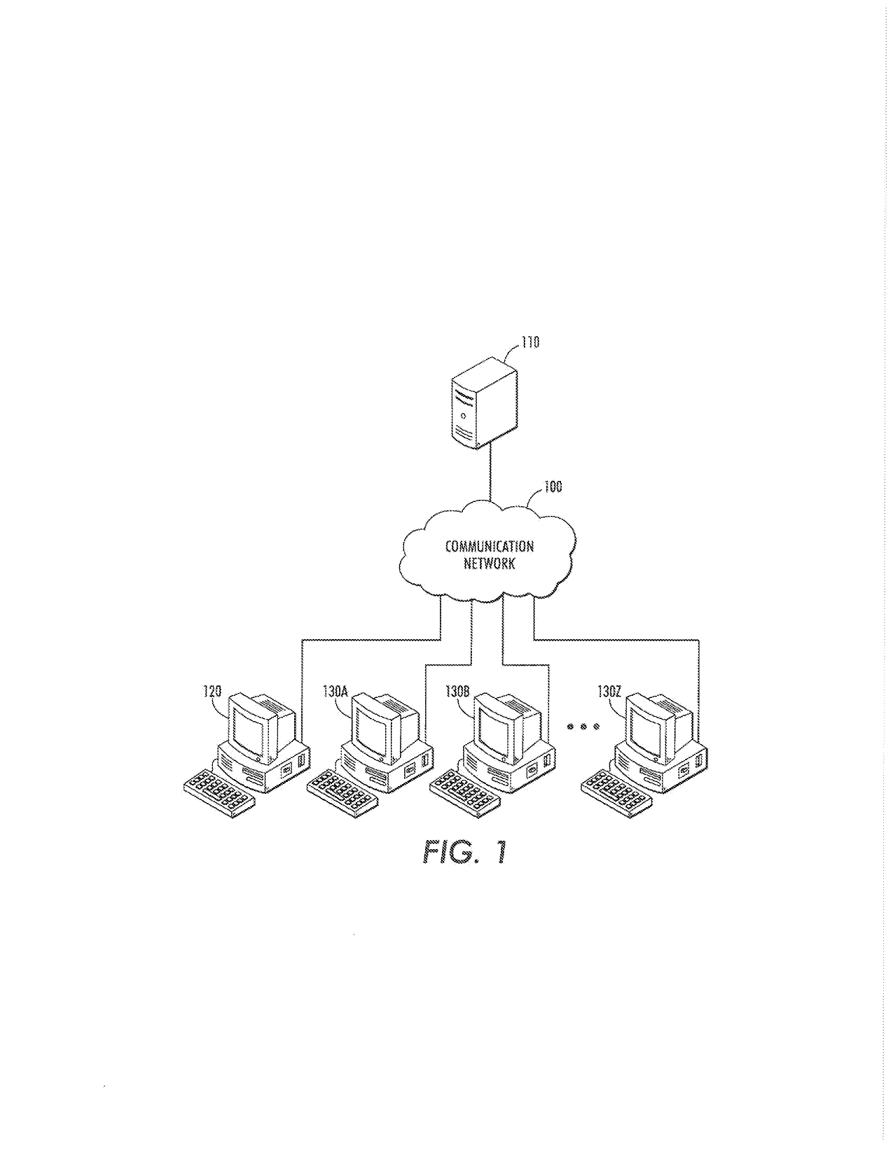

FIG. 1 is a diagram depicting an exemplary network configuration that may be used to conduct an online auction that provides for a post-auction change order with a change auction option, consistent with certain disclosed embodiments. As depicted in FIG. 1, an auction server 110 may communicate with a plurality of client devices 120 and 130a-130z through a communication network 100, such as the Internet. For example, an auctionor might participate in an online auction using client machine 120, and one or more bidders might participate using client machine 130a-130z. Auction server 110 may be any type of computing device configured by software operative to enable auction server 110 to host auctions and communicate with one or more client machines 120 and 130a-130z over communication network 100. Auction server 110 is depicted in FIG. 1 as a single device, but different implementations may use multiple devices working independently or as a system.

Auctionor client machine 120 and bidder client machines 130a-130z, may be configured by software operative to perform various functions including, but not limited to, initiating auctions; bidding on auctions; proposing change orders; proposing, selecting, or rejecting post-auction change auction options; and executing financial transactions through auction server 110 and/or another transactional server over communication network 100.

Those skilled in the art will appreciate that the foregoing network arrangement is exemplary only. For example, in some embodiments, auction server 110 and any one of client machines 120 and 130a-130z may be the same machine.

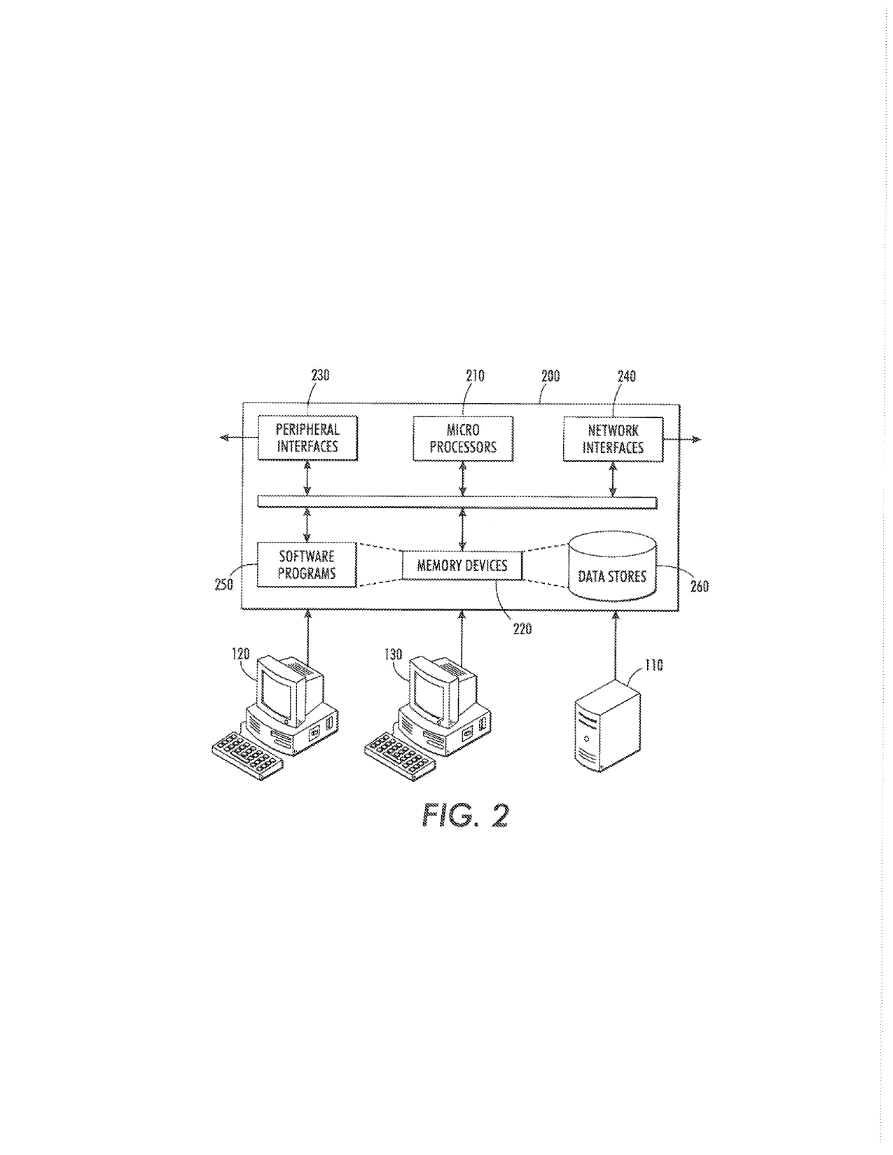

FIG. 2 is a diagram depicting an exemplary hardware configuration 200 for various devices that may be used to perform one or more operations of the described embodiments. As further described below, some operations may be performed by one or more of client devices 120 and 130, which may be, for example, traditional personal computing devices, such as desktop or laptop computers; mobile devices, such as smartphones or tablets; kiosk terminals, etc. Various operations may also be performed by auction server 110, which may be a rack-mounted server device or a conventional desktop computing device, capable of serving webpages and executing server-side scripts or programs.

Any of client devices 120 and 130 or auction server 110 may perform operations pursuant to executable or interpretable code resident in memory. In some cases, various operations performed by client devices 120 and 130 may be performed pursuant to client-side code received from one or more external devices, such as auction server 110, during the auction process.

Any of devices 110, 120, and 130 may comprise one or more microprocessors 210 of varying core configurations and clock frequencies; one or more memory devices or computer-readable media 220 of varying physical dimensions and storage capacities, such as flash drives, hard drives, random access memory, etc., for storing data, such as images, files, and program instructions for execution by one or more microprocessors 210; one or more network interfaces 240, such as Ethernet adapters, wireless transceivers, or serial network components, for communicating over wired or wireless media using protocols, such as Ethernet, wireless Ethernet, code divisional multiple access (CDMA), time division multiple access (TDMA), etc.; and one or more peripheral interfaces 230, such as keyboards, mice, touchpads, computer screens, touchscreens, etc., for enabling human interaction with and manipulation of any of devices 110, 120, and 130. In some embodiments, the components of hardware configuration 200 need not be enclosed within a single enclosure or even located in close proximity to one another.

Memory devices 220 may further be physically or logically arranged or configured to provide for or store one or more data stores 260, such as one or more file systems or databases, and one or more software programs 250, which may contain interpretable or executable instructions for performing one or more of the disclosed embodiments. Those skilled in the art will appreciate that the above-described componentry is exemplary only, as devices 110, 120, and 130 may comprise any type of hardware componentry, including any necessary accompanying firmware or software, for performing the disclosed embodiments. Devices 110, 120, and 130 may also be implemented in part or in whole by electronic circuit components or processors, such as application-specific integrated circuits (ASICs) or field-programmable gate arrays (FPGAs).

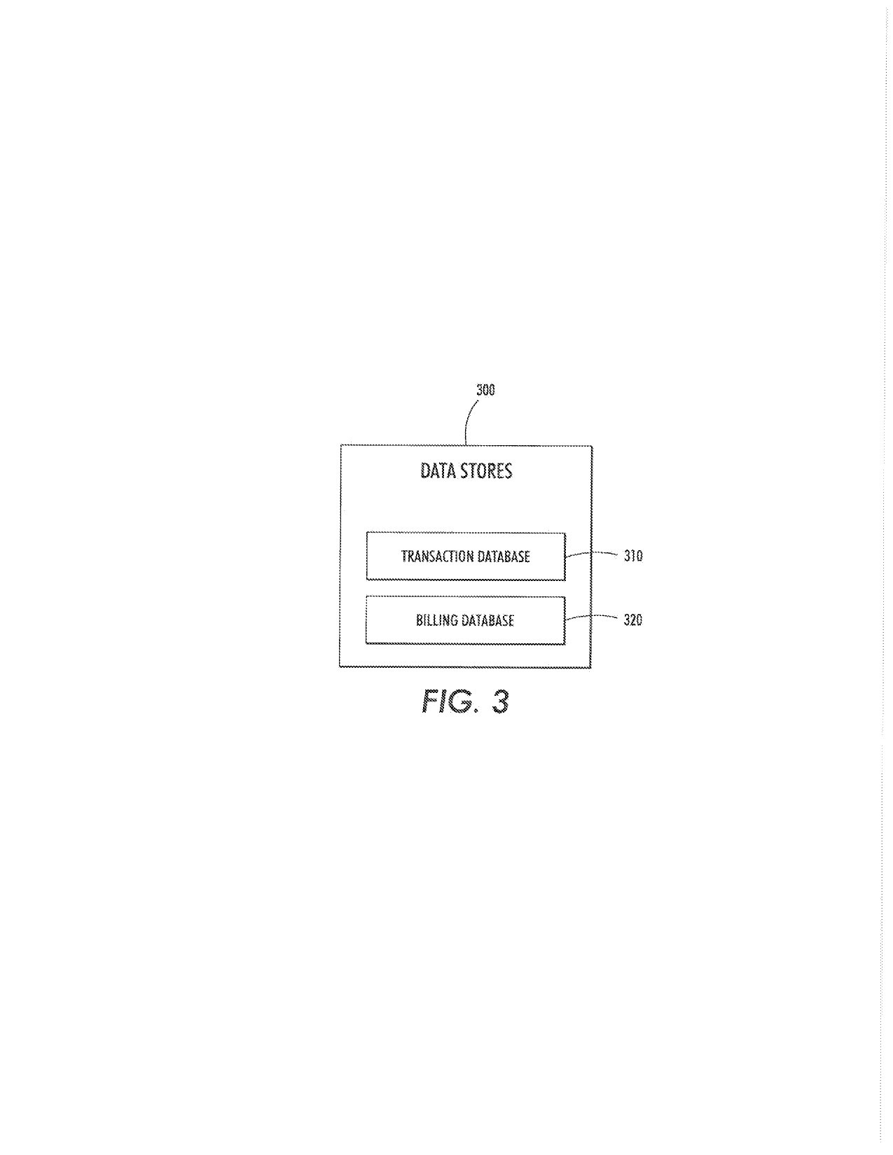

FIG. 3 is a diagram depicting an exemplary data store configuration for an online auction system that may be used to perform one or more operations of the described embodiments. Data store 300 may include a transaction database 310 that may be used by auction server 110 to store information related to various operations including, but not limited to, calculating an optimum switch ratio and determining prices after a change order. Data store 300 may also include a billing database 320, which may be used by auction server 110 to store information used to perform monetary transactions between any of client machines 120 and 130 and auction server 110.

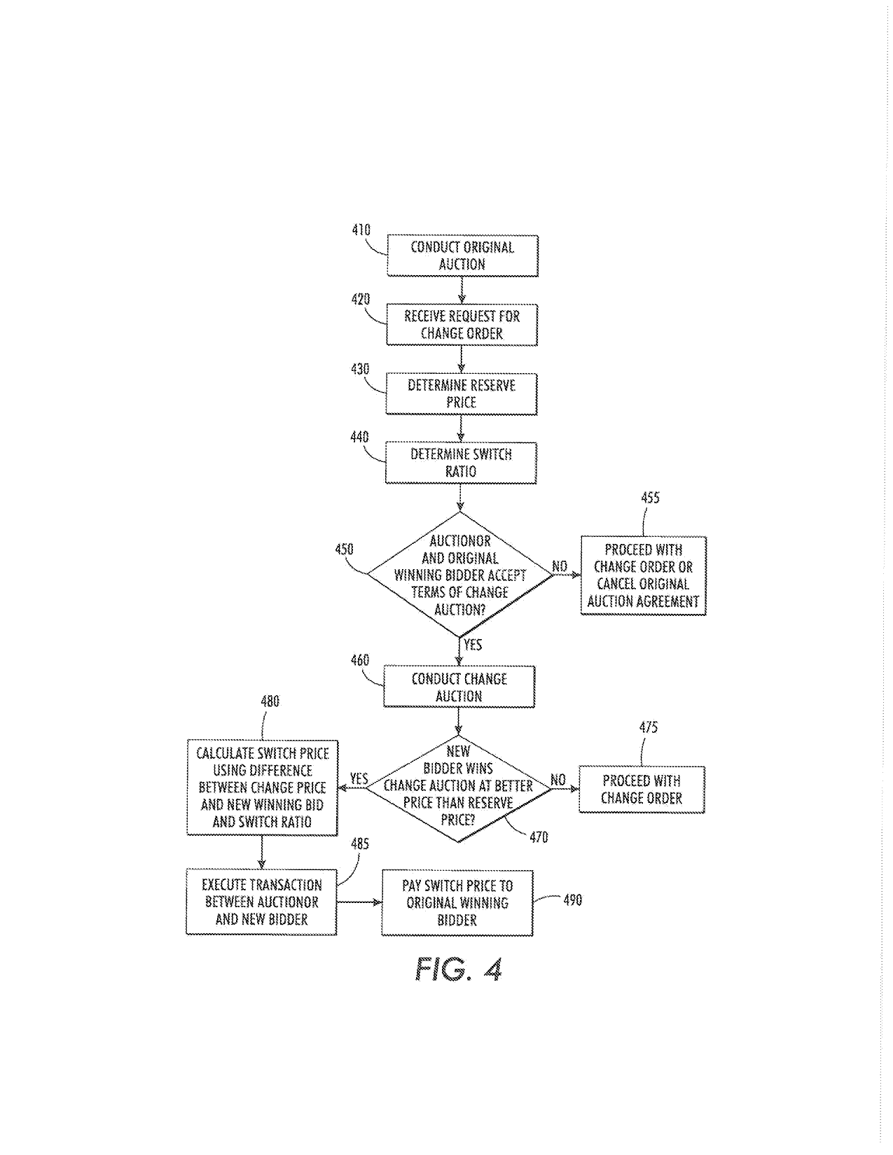

FIG. 4 is a flow diagram illustrating an exemplary method of implementing a post-auction change order with a change auction option, consistent with certain disclosed embodiments. The steps depicted in FIG. 4 may be performed by or through auction server 110 and one or more client machines 120 and 130 over communication network 100.

In step 410, an auctionor—e.g., using auctionor client machine 120—may send a request to an auction server—e.g., auction server 110—to conduct an auction (hereinafter “original auction”) to buy or sell a service or good. The original auction may conclude when a single bidder (hereinafter “original winning bidder”)—e.g., using bidder client machine 130a—wins the original auction by outbidding all other bidders. Thus, step 410 may further involve an agreement between the auctionor and the original winning bidder to buy or sell the goods or services at a price equal to the original winning bid.

After the original auction has concluded and the original auction agreement has been reached, one or both parties may experience a change in circumstances that necessitates a change order. A change order may be an agreement between the parties to alter the terms of the original agreement. Alterations to the terms of the original agreement may include, but are not limited to, different prices, different quantities, different delivery schedules, different methods of payment, different quality of materials, and/or different combinations of the foregoing. Examples of changes in circumstances that could necessitate a change order include, but are not limited to, a material cost increase in the good or service or a material change in the amount of goods or services required.

Thus, in step 420, either party may request a change order and specify a change price and/or a change quantity that reflects the change of circumstances. The change quantity may be based on, for example, new requirements of the buyer, an amount that the seller is capable of supplying, negotiations between the buyer and the seller, etc. Additionally, the change quantity may be based on or equal to the original agreement quantity. The change price may likewise be based on various factors, including, but not limited to, bargaining between the two parties, input from the buyer, input from the seller, or analysis of the stored history of similar past transactions in database 310. Similar to the change quantity, the change price may also be based on or equal to the original agreement price.

However, rather than simply proceeding with a conventional change order, auction server 110 may present the parties with an opportunity to subject the terms of the change order to a change auction. In step 430, auction server 110 (or another device) may determine terms of the change auction, including a reserve price and a change auction quantity. In some embodiments, the reserve price may initially or ultimately be set equal to the change price of the change order. Likewise, in some embodiments, the change auction quantity may initially or ultimately be set equal to the change quantity of the change order.

In step 440, a switch ratio may be determined. In some embodiments, the switch ratio may be a number greater than zero but less than one that may be used to calculate a switch price. The switch price may be used to incentivize the original winning bidder to agree to the change auction. In particular, the switch price may be paid to the original winning bidder in the event that a new winning bidder is successful in the change auction. The switch ratio may be determined using a variety of techniques, including, but not limited to, receiving direct input from the auctionor or the original winning bidder, bargaining between the auctionor and the original winning bidder through auction server 110, and analyzing the stored history of similar past transactions in database 310.

In some embodiments, once the switch ratio has been determined, the auctionor may elect to utilize the change auction, and the original winning bidder may choose whether to allow or reject the change auction at the determined switch ratio (step 450). In other embodiments, the auctionor may elect to utilize the change auction before the switch ratio is determined.

In some embodiments, the original winning bidder may have the option to reject the terms of the change order, including, but not limited to, the change auction election, the change price, the change quantity, the reserve price, the change auction quantity, and the switch ratio. If the original winning bidder rejects specified terms of the change order, then the original winning bidder may proceed to negotiate with the auctionor to determine adequate terms before agreeing to the change auction.

Negotiations may be conducted utilizing functionality provided by auction server 110 or may be conducted without using auction server 110 as an intermediary. If the auctionor does not elect to utilize the change auction, or if the original winning bidder rejects the change auction election (step 450, No), then the auctionor and the original winning bidder may proceed with the original change order at the change price and change quantity, or the auction may be canceled altogether (step 455).

If, in step 455, the auctionor and the original winning bidder proceed with the original change order, then, in some embodiments, the buyer, whether the auctionor or the original winning bidder, may pay the change price to the other party using auction server 110 or another, third-party transaction server. The buyer may pay the change price in full or in increments, as per the change order agreement with the seller. Auction server 110 may then store data reflecting the transaction in billing database 320.

If auction server 110 is also the transaction server, then it may credit the seller's account with the appropriate amount. For example, the seller may be credited by an amount that is less than or equal to the change price, as auction server 110 may or may not subtract a fee from the amount paid by the buyer before crediting the seller. The seller may then elect to leave that amount in its account or transfer the funds out of the account using methods known in the art. The seller may perform its obligations under the agreement before payment, after partial payment, or after full payment, as per the agreement. In other embodiments the financial transactions may be executed through one or more servers other than auction server 110.

If, in the alternative, the auctionor elects to subject the change order to a change auction and the original winning bidder agrees to the change auction at a specified switch ratio (step 450, Yes), whether initially or after negotiations, then, in step 460, a change auction may then be held. In some embodiments, the change auction may be conducted as an auction for the same goods or services that were offered in the original auction at a change auction quantity that is equal to the change quantity. However, the change auction quantity need not be limited to the change quantity, but may encompass any quantity of goods or services.

In some embodiments, the reserve price may be regarded as effectively the first bid in the change auction, and any additional bids must outbid the reserve price to be accepted by auction server 110. If no new bidder outbids the reserve price (step 470, No), then, in step 475, the auctionor and the original winning bidder may simply proceed with the change order. Accordingly, the buyer may pay the change price and receive goods or services from the seller in an amount equal to the change quantity. Any financial transactions may be conducted as described above.

Conversely, if there is a new winning bidder that out bids the reserve price and any other bidders in the change auction (step 470, Yes), then the new winning bidder may enter into an agreement with the auctionor for exchange of the change auction quantity of goods or service at a price equal to the new winning bidder's winning bid (hereinafter, “new winning bid”).

After the new winning bid amount has been determined, the switch price to be paid to the original winning bidder may be calculated. In step 480, the switch price may be calculated using the change price, the new winning bid, and the switch ratio. First, the auctionor's gross benefit obtained through the use of the change auction (hereinafter, “gross benefit”) may be determined by calculating the difference between the change price and the new winning bid. For example, if the auctionor is the buyer, then the gross benefit may be determined by subtracting the new winning bid from the change price.

Alternatively, if the auctionor is the seller, then the gross benefit may be determined by subtracting the change price from the new winning bid. Accordingly, the gross benefit may represent the total benefit netted by the auctionor through the use of the change auction, as compared to what the auctionor would have paid or would have been paid using a traditional change order. After the gross benefit has been calculated, the switch price may be calculated by multiplying the switch ratio by the gross benefit.

In some embodiments, in step 485, after the switch price has been determined, the auctionor and the new winning bidder may execute an agreement using a process similar to the process described for proceeding with the change order in step 455. However, if the auctionor is a buyer, then, in addition to paying the new winning bid amount, the buyer may also pay the switch price. Conversely, if the auctionor is a seller, then the switch price may be deducted from the amount paid by the new winning bidder before the funds are transferred to the auctionor.

As a result, in step 490, the original winning bidder may be paid the switch price. In another embodiment, the winning bidder may receive the switch price payment directly from the auctionor, and the transaction between the new winning bidder and the auctionor may proceed similar to the financial transactions described for step 455.

Those skilled in the art will appreciate that the foregoing sequence of steps is exemplary only, and that other sequences may be used for performing embodiments of the invention. For example, in some embodiments, the original winning bidder may be the party that requires a change order. Accordingly, the original winning bidder may propose a change order that is subject to a change auction. In this embodiment, the auctionor may choose to allow or reject the terms of the change order, including, but not limited to, the change price, the change quantity, the change auction election, the reserve price, or the change auction quantity.

Additionally, in the embodiment depicted in FIG. 4, the auctionor in the original auction is also the auctionor in the change auction. However, in other embodiments, the original winning bidder may be the party that holds the change auction, and the auctionor in the original auction may be paid a switch price in the event of a successful change auction.

Furthermore, in the embodiment depicted in FIG. 4, the original auction results in an agreement between the auctionor and the original winning bidder to buy or sell goods or services at a price equal to the original winning bid. However, in other embodiments, the agreement between the auctionor and the original winning bidder may be to buy or sell the goods or services at a price that is higher or lower than the original winning bid. For example, the agreement price may be equal to an amount bid by the next highest bidder below the winning bidder (known as a “second price auction”) or may be equal to the original winning bid multiplied by a fixed percentage. Similarly, the change price specified in a change auction agreement between the auctionor and the new winning bidder as a result of a change auction need not be equal to the new winning bidder's bid amount, but may differ for similar or other reasons.

Moreover, in the embodiment depicted in FIG. 4, the change auction is proposed as part of the change order agreement. However, in other embodiments, the change order agreement may be executed without a change auction election and, subsequently, the parties to the completed change order agreement may later agree to hold a change auction.

Furthermore, in the embodiment depicted in FIG. 4, the switch price is calculated using the change price. However, in other embodiments, the switch price may be calculated using any value, including, but not limited to, the reserve price from the change auction.

Still further, in the embodiment depicted in FIG. 4, all bids in the change auction must outbid the reserve price. However, in other embodiments, auction server 110 may accept bids that do not outbid the reserve price including bids that are equal to reserve price, bids that are greater than the reserve price, or bids that are less than the reserve price, depending on the implementation.

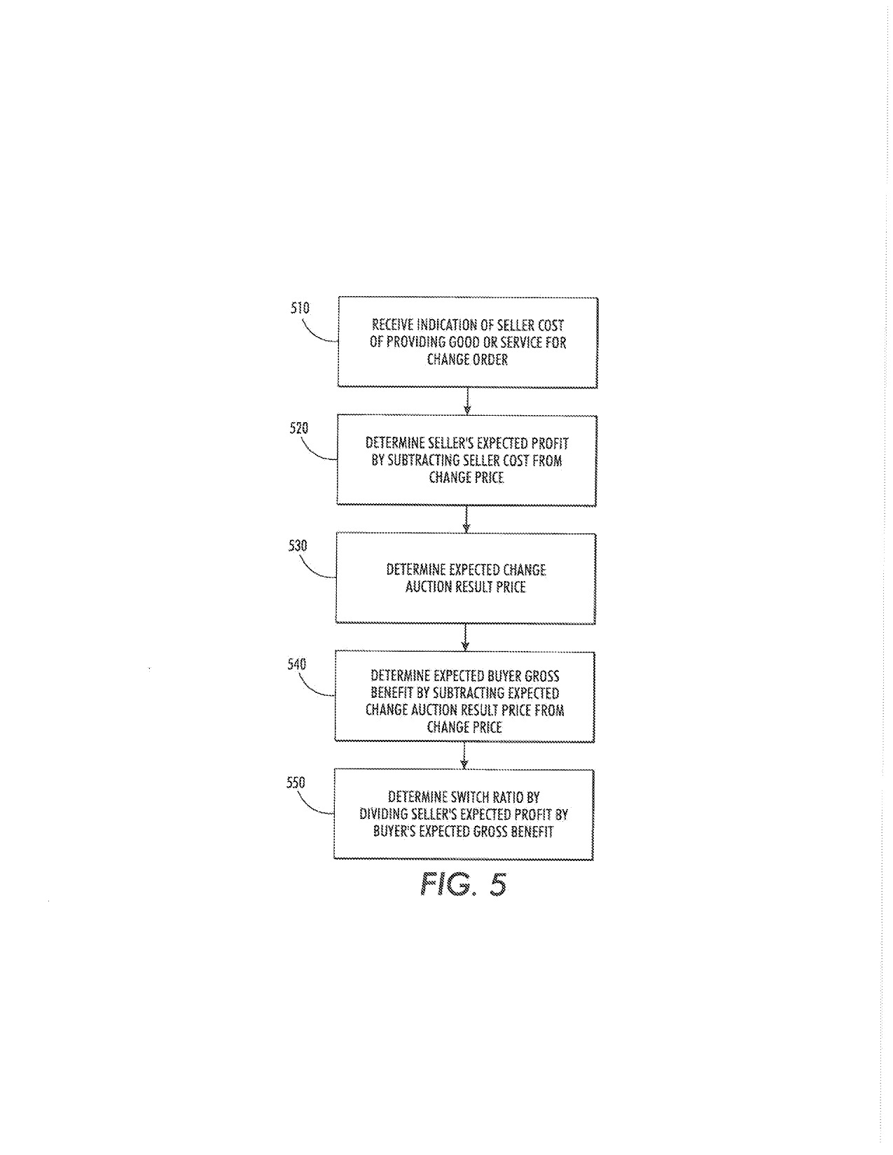

FIG. 5 is a flow diagram illustrating an exemplary method of calculating a switch ratio, consistent with certain disclosed embodiments. The following sequence may represent the steps performed by auction server 110 during step 440, as depicted in FIG. 4. For the purposes of this example, the auctionor is a buyer and all bidders are sellers. Those skilled in the art will appreciate that the following sequence of steps is exemplary only, and that other sequences of steps for performing embodiments of the invention may be used.

In some cases, in order to incentivize the original winning bidder to accept a change auction election, an optimum switch ratio may be calculated to indicate a switch ratio in which the original winning bidder may expect to obtain a switch price equal to its expected profits from the change order. The process for calculating an optimum switch ratio may begin in step 510, when auction server 110 may determine or receive an indication of the seller's cost of providing the change quantity of goods or services at the proposed change price. The seller's cost may be determined using a variety of methods including, but not limited to, direct input from the seller, analyzing data related to the auction, or analyzing similar transactions from transaction database 310.

In step 520, auction server 110 may determine the seller's expected profits from the requested change order at the proposed change price. The expected profits may be determined using a variety of methods including, but not limited to, direct input from the seller or subtracting the seller's expected cost, determined in step 510, from the proposed change price.

In step 530, auction server 110 may determine the expected change auction result price. The expected change auction result price may represent the amount of a new winning bid, if any, that would be expected if a change auction were conducted. Auction server 110 may determine the expected change auction result price using a variety of methods including, but not limited to, analyzing similar transactions from transaction database 310 or from direct input from a client machine. If the expected change auction result price is not lower than the proposed change price, then the change auction may not be beneficial to both parties and, accordingly, an optimal switch ratio might not be obtained.

If the expected change auction result price is lower than the proposed change price, then, in step 540, auction server 110 may calculate the buyer's expected gross benefit from the change auction by subtracting the expected change auction result price from the proposed change price. The buyer's expected gross benefit may represent the total amount, prior to paying the switch price, that the buyer would expect to save by paying the change auction winning bid price instead of the proposed change price.

Finally, in step 550, auction server 110 may calculate an optimum switch ratio by dividing the seller's expected profit, determined in step 520, by the auctionor's expected gross benefit, calculated in step 540. If step 550 yields a number greater than one, then the change auction may not be beneficial for the seller because the seller's expected profit from the change order is greater than the auctionor's expected gross benefit from the change auction. Accordingly, an optimal switch ratio might not be obtained. Similarly, if step 550 results in a switch ratio of one, then the change auction may not be beneficial to the seller because the seller's expected profit from the change order would be equal to the auctionor's expected gross benefit from the change auction. Therefore, an optimum switch ratio might not be obtained.

If the result of step 550 is a number that is less than one, the result may represent an optimum switch ratio such that the seller could expect to receive the same amount of profit whether it agrees to or rejects the change auction. In some embodiments, the optimum switch ratio may be used as the switch ratio in step 440 of the process depicted in FIG. 4, or, in other embodiments, the optimum switch ratio may be used by the seller and/or the buyer to determine whether a proposed switch ratio would be mutually beneficial or whether they should barter for a different switch ratio.

While the steps depicted in FIG. 5 have been described as being performed by auction server 110, one or more steps may instead be performed by auctionor client device 120 or any other device connected to communication network 100 and involved in the auction or transaction process.

Moreover, while the steps depicted in FIG. 5 are directed to an exemplary technique for determining an optimum switch ratio when the auctionor is a buyer, similar techniques may be used to determine an optimum switch ratio when the auctionor is a seller. For example, the process may begin in step 520, when auction server 110 may determine the buyer's expected profits from the requested change order at the proposed change price by subtracting the proposed change price from the buyer's expected resale price. In step 520, auction server 110 may determine the expected change auction result price, as described above. In step 540, auction server 110 may calculate the seller's expected gross benefit from the change auction by subtracting the proposed change price from the expected change auction result price. Finally, in step 550, auction server 110 may determine the optimum switch ratio by dividing the buyer's expected profits by the seller's expected gross benefit.

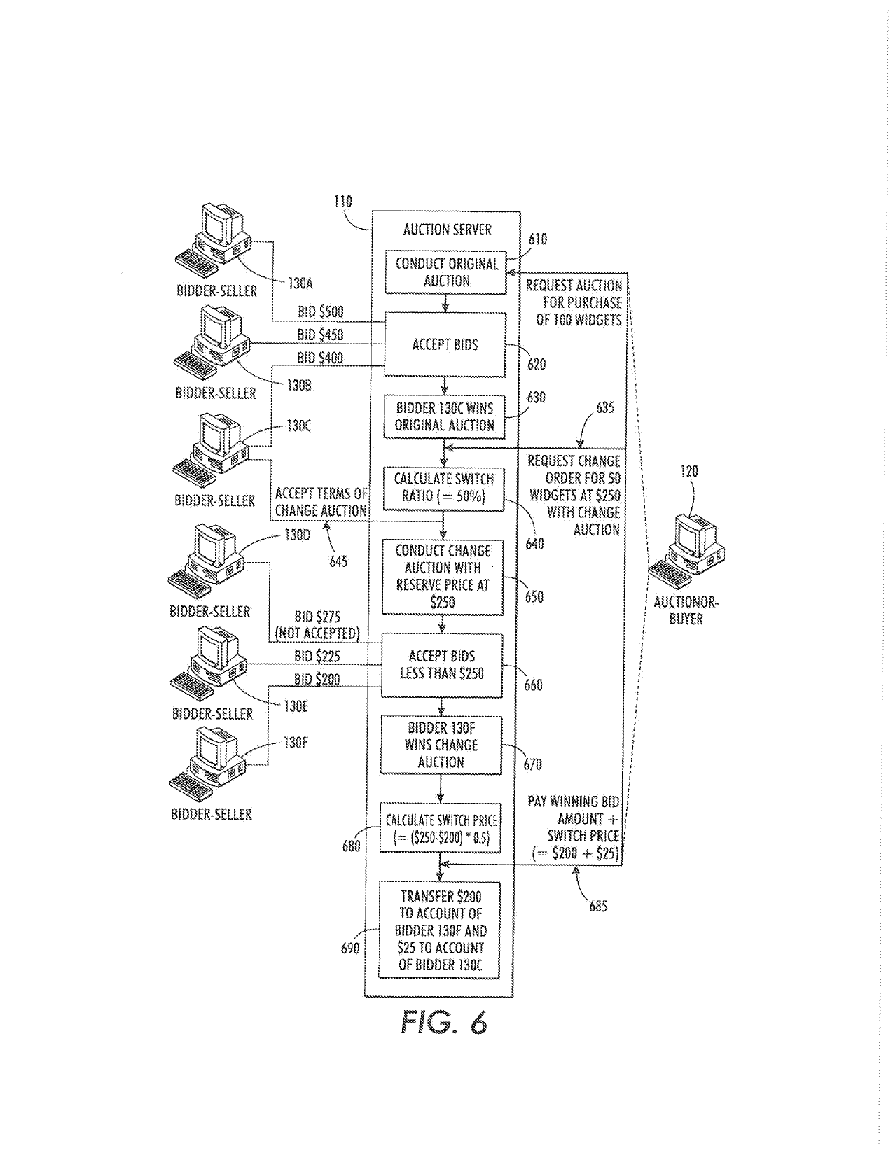

FIG. 6 is a flow diagram depicting an exemplary sequence in which a change auction may be conducted as part of a change order during the post-auction period of a completed auction, consistent with certain disclosed embodiments. As depicted in FIG. 6, auction server 110 may conduct online auctions in which it communicates with auctionor-buyer 120 and bidder-sellers 130a-130f. In the example depicted in FIG. 6, auctionor-buyer 120 is attempting to purchase widgets and bidder-sellers 130a-130f are attempting to sell widgets using online auction functionality provided by auction server 110.

In step 610, auctionor-buyer 120 transmits a request to auction server 110 to conduct an online auction (“original auction”) for the purchase of 100 widgets. In response to the request, auction server 110 conducts or facilitates the original auction.

In step 620, auction server 110, as part of the original auction, accepts bids from bidder-sellers 130a-130c. For example, bidder-sellers 130a-130c may place bids in which they offer to the sell the requested 100 widgets for $500, $450, and $400, respectively.

In step 630, auction server 110 determines that bidder-seller 130c has outbid the other bidders (i.e. bid the lowest price for the 100 widgets) and is therefore the winner of the original auction (“original winning bidder”). Accordingly, an original auction agreement is established in which bidder-seller 130c has agreed to sell 100 widgets to auctionor-buyer 120 for $400.

However, in this example, before the performance of the original auction agreement, auctionor-buyer encounters a change in circumstances, as a result of which, auctionor-buyer 120 requires only 50 widgets. Accordingly, in step 635, auctionor-buyer 120 requests a change order to purchase only 50 widgets. Here, the change order specifies a change price of $250, which may have been requested unilaterally by auctionor-buyer 120, or may have been tentatively agreed to by auctionor-buyer 120 and bidder-seller 130c after negotiation.

In step 640, auction server 110 calculates a switch ratio of 50%, which may be calculated, for example, using one or more of the steps described with respect to FIG. 5. Then, in step 645, bidder-seller 130c agrees to the terms of the change order which includes the change quantity (50 widgets), the change price ($250), the use of the change auction, and the switch ratio (50%).

In step 650, auction server 110 initiates a change auction. In this example, the change auction quantity is equal to the change quantity of 50 widgets, and the reserve price is equal to the change price of $250. Subsequently, in step 660, auction server 110 accepts bids from bidder-sellers 130d-130f to sell the requested 50 widgets. Because the reserve price is equal to $250, in this embodiment, auction server 120 will accept only bids that are less than $250. Accordingly, auction server 110 may not accept bidder-seller 130d's bid of $275 while accepting a bid of $225 from bidder-seller 130e and a bid of $200 from bidder-seller 130f.

In step 670, auction server 110 determines that bidder-seller 130f has outbid the other bidders in the change auction (i.e., has bid the lowest price for the 50 widgets) and is therefore the new winning bidder. Accordingly, a change auction agreement is established in which bidder-seller 130f has agreed to sell 50 widgets to auctionor-buyer 120 for $200.

In step 680, auction server 110 calculates the switch price using the switch ratio calculated in step 640 and accepted by bidder-seller 130c in step 645. In this embodiment, the switch price is calculated by multiplying the switch ratio of 50% by the difference in price between the change price of $250 and bidder-seller 130f's winning bid of $200. Here, the difference between the change price of $250 and bidder-seller 130f's winning bid of $200 is $50, which is then multiplied by the switch ratio of 50%, resulting in a switch price of $25.

In step 685, auctionor-buyer 120 pays a total amount of $225 to auction server 110, which represents bidder-seller 130f's winning bid of $200 in the change auction plus the switch price of $25. Finally, in step 690, auction server 110 transfers $200 to bidder-seller 130f's account and transfers $25 to bidder-seller 130c's account.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. The steps described need not be performed in the same sequence discussed or with the same degree of separation. Likewise various steps may be omitted, repeated, or combined, as necessary, to achieve the same or similar objectives or enhancements. Accordingly, the invention is not limited to the above-described embodiments, but instead is defined by the appended claims in light of their full scope of equivalents.

In the above description and in the below claims, unless specified otherwise, the term “good” and its derivations may refer to any item that may be purchased, as distinct from a service, and may include tangible and intangible items, including real estate.

What is claimed is:

1. A computer-implemented method of facilitating a modification to an auction agreement, the method comprising:
receiving an indication of a requested modification to an agreement associated with a first auction between an auctionor and a first bidder; and
initiating a second auction process, comprising:
receiving one or more bids;
identifying a winning second bidder, wherein the winning second bidder is associated with a winning bid, from among the received bids, that outbids a reserve price; and
in response to identifying the winning second bidder, crediting the first bidder with a portion of a price paid to the second bidder or the auctionor as a result of the second bidder's winning bid.

2. The method of claim 1, wherein:
the agreement associated with the first auction relates to the auctionor selling a good or service to the first bidder.

3. The method of claim 1, wherein:
the agreement associated with the first auction relates to the auctionor buying a good or service from the first bidder.

4. The method of claim 1, wherein:
the first auction regards a specified good or service at a first specified quantity and a first specified price; and
the requested modification to the agreement associated with the first auction regards at least one of:
the specified good or service of the first auction at a second specified quantity that differs from the first specified quantity; and
a second specified price that differs from the first specified price.

5. The method of claim 4, wherein at least one of:
the second auction regards the specified good or service of the first auction at a quantity based on the second specified quantity; and
the reserve price is based on the second specified price.

6. The method of claim 1, wherein:
the reserve price is based on a price associated with the requested modification to the agreement associated with the first auction.

7. The method of claim 6, wherein:
the reserve price is equal to the price associated with the requested modification to the agreement associated with the first auction.

8. The method of claim 1, wherein:
the portion credited to the first bidder is an amount that is less than a difference between the price paid and the reserve price.

9. The method of claim 2, wherein the portion credited to the first bidder is determined based on operations comprising:
determining an expected profit of the first bidder from buying the good or service at a price associated with the requested modification;
determining a likely winning bid amount for the second auction;
determining an expected benefit of the auctionor for the second auction by subtracting the price associated with the requested modification from a price associated with the likely winning bid amount;
determining an optimum switch ratio by dividing the expected profit by the expected benefit; and
determining the portion credited to the first bidder by multiplying the price paid to the auctionor minus the price associated with the requested modification by the optimum switch ratio.

10. The method of claim 3, wherein the portion credited to the first bidder is determined based on operations comprising:
determining an expected profit of the first bidder from selling the good or service at a price associated with the requested modification;
determining a likely winning bid amount for the second auction;
determining an expected benefit of the auctionor for the second auction by subtracting a price associated with the likely winning bid amount from the price associated with the requested modification;
determining an optimum switch ratio by dividing the expected profit by the expected benefit; and
determining the portion credited to the first bidder by multiplying the price associated with the requested modification minus the price paid to the second bidder by the optimum switch ratio.

11. The method of claim 9, wherein determining the likely winning bid amount comprises:
consulting one or more previous transactions related to the good or service.

12. The method of claim 10, wherein determining the likely winning bid amount comprises:
consulting one or more previous transactions related to the good or service.

13. A system configured to facilitate a modification to an auction agreement, the method comprising:
a processing system comprising one or more processors; and
a memory system comprising one or more computer-readable media, wherein the computer-readable media contains instructions stored thereon that, if executed by the processing system, cause the system to perform operations comprising:
receiving an indication of a requested modification to an agreement associated with a first auction between an auctionor and a first bidder; and
initiating a second auction process, comprising:
receiving one or more bids;
identifying a winning second bidder, wherein the winning second bidder is associated with a winning bid, from among the received bids, that outbids a reserve price; and
in response to identifying the winning second bidder, crediting the first bidder with a portion of a price paid to the second bidder or the auctionor as a result of the second bidder's winning bid.

14. The system of claim 13, wherein:
the agreement associated with the first auction relates to the auctionor selling a good or service to the first bidder.

15. The system of claim 13, wherein:
the agreement associated with the first auction relates to the auctionor buying a good or service from the first bidder.

16. The system of claim 13, wherein:
the first auction regards a specified good or service at a first specified quantity and a first specified price; and
the requested modification to the agreement associated with the first auction regards at least one of:
the specified good or service of the first auction at a second specified quantity that differs from the first specified quantity; and
a second specified price that differs from the first specified price.

17. The system of claim 16, wherein at least one of:
the second auction regards the specified good or service of the first auction at a quantity based on the second specified quantity
the reserve price is based on the second specified price.

18. The system of claim 13, wherein:
the reserve price is based on a price associated with the requested modification to the agreement associated with the first auction.

19. The system of claim 18, wherein:
the reserve price is equal to the price associated with the requested modification to the agreement associated with the first auction.

20. The system of claim 13, wherein:
the portion credited to the first bidder is an amount that is less than a difference between the price paid and the reserve price.

21. The system of claim 14, wherein the portion credited to the first bidder is determined based on operations comprising:
determining an expected profit of the first bidder from buying the good or service at a price associated with the requested modification;
determining a likely winning bid amount for the second auction;
determining an expected benefit of the auctionor for the second auction by subtracting the price associated with the requested modification from a price associated with the likely winning bid amount;
determining an optimum switch ratio by dividing the expected profit by the expected benefit; and
determining the portion credited to the first bidder by multiplying the price paid to the auctionor minus the price associated with the requested modification by the optimum switch ratio.

22. The system of claim 15, wherein the portion credited to the first bidder is determined based on operations comprising:
determining an expected profit of the first bidder from selling the good or service at a price associated with the requested modification;
determining a likely winning bid amount for the second auction;
determining an expected benefit of the auctionor for the second auction by subtracting a price associated with the likely winning bid amount from the price associated with the requested modification;
determining an optimum switch ratio by dividing the expected profit by the expected benefit; and
determining the portion credited to the first bidder by multiplying the price associated with the requested modification minus the price paid to the second bidder by the optimum switch ratio.

23. The system of claim 21, wherein determining the likely winning bid amount comprises:
consulting one or more previous transactions related to the good or service.

24. The system of claim 22, wherein determining the likely winning bid amount comprises:
consulting one or more previous transactions related to the good or service.

25. A computer-implemented method of facilitating a modification to an auction agreement, the method comprising:
receiving an indication of a requested modification to an agreement associated with a first auction between an auctionor and a first bidder, wherein:
the agreement associated with the first auction relates to the auctionor buying a good or service from the first bidder at a first price and a first quantity; and
the requested modification to the agreement associated with the first auction relates to a request for the auctionor to buy the good or service from the first bidder at a second price that differs from the first price and at a second quantity that differs from the first quantity;
determining an optimum switch price ratio, comprising:
determining an expected profit of the first bidder from selling the good or service at the second price;
determining a likely winning bid amount for a second auction for the good or service at the second quantity;
determining an expected benefit of the auctionor for the second auction by subtracting the likely winning bid amount from the second price;
determining the optimum switch ratio by dividing the expected profit by the expected benefit;
initiating the second auction process, comprising:
receiving one or more bids for the good or service at the second quantity;
identifying a winning second bidder, wherein the winning second bidder is associated with a winning bid, from among the received bids, that outbids a reserve price that is equal to the second price;
determining a switch price by multiplying the second price minus the second bidder's winning bid by the optimum switch ratio; and
crediting the first bidder with the switch price.
